(19) United States
(12) Patent Application Publication
(10) Pub. No.: US 2025/0260089 A1
(43) Pub. Date: Aug. 14, 2025

(54) TEMPERATURE-CONTROLLABLE BATTERY HOUSING AND METHOD FOR MANUFACTURING THE SAME

(71) Applicant: TI Automotive Technology Center GmbH, Restatt (DE)

(72) Inventor: Moez HAOUALA, Karlruhe (DE)

(21) Appl. No.: 19/045,714

(22) Filed: Feb. 5, 2025

(30) Foreign Application Priority Data
Feb. 8, 2024 (DE) 102024103617.6

(51) Int. Cl. H01M 10/6556; H01M 10/613; H01M 10/625; H01M 50/103

(52) U.S. Cl. CPC H01M 10/6556; H01M 10/613; H01M 10/625; H01M 50/103; H01M 2220/20

(57) ABSTRACT

A battery housing for an electric vehicle battery includes a housing wall comprised of a plastic. The battery housing comprises a fluid conduit for a temperature-regulating means. The fluid conduit is at least partially embedded in the housing wall.

### RELATED APPLICATIONS

The present disclosure claims priority to and the benefit of German Application 10 2024 103 617.6, filed on Feb. 8, 2024, the entire contents of each of which are incorporated herein by reference.

### FIELD

The disclosure relates to a battery housing for an electric vehicle battery of a vehicle having at least one fluid conduit for a temperature control medium. The disclosure further relates to an electric vehicle battery comprising a battery housing and a use of a battery housing or an electric vehicle battery. Finally, the disclosure relates to a method for manufacturing a battery housing.

### BACKGROUND

The temperature control function of the electric vehicle battery or battery housing is very important for electric vehicles, as it ensures that the battery cells are always maintained at the optimum temperature for traction batteries (approximately room temperature). This not only ensures optimum driving performance throughout the seasons and overcomes temperature changes during a journey, but also applies to the charging process. This is because during charging, especially very fast charging, the traction batteries become very warm. Only with a high-performance thermal management system for the electric vehicle battery very fast charging processes can be achieved.

A battery housing typically has an upper and a lower housing shell. The two housing shells house a large number of battery cells, numerous electrical connections and some electronic components. The battery housing also includes a fluid conduit that is routed in a meandering pattern inside an aluminum plate. The aluminum plate has two aluminum subplates that rest on top of each other and are firmly connected to each other, with at least one of the two subplates comprising a meandering embossing. The embossing of the at least one partial plate complements the other partial plate to form the meandering fluid conduit within the aluminum plate.

At least one, but usually several, aluminum plates, each with at least one fluid conduit, are attached by screws to an inner side of the upper and/or lower housing shell and connected by line connectors to supply lines, in particular plastic manifolds. For example, a collector tube can supply three aluminum plates in the lower and three further aluminum plates in the upper housing shell as a supply line. Another collector tube can collect the fluid flows heated (or cooled) by the battery cells and supply them to a temperature control element so that the temperature control fluid is cooled (or heated) and the cycle can start again.

However, we have found the effort required to provide the fluid conduit within the electric vehicle battery is quite high.

### BRIEF SUMMARY

A battery housing is provided for an electric vehicle battery of a vehicle, comprising a housing wall, the housing wall comprising a plastic, the battery housing comprising at least one fluid conduit for a temperature control medium, and characterized in that the fluid conduit is at least partially embedded in the housing wall.

The disclosure is based on the finding that the provision of aluminum plates is costly, which mainly concerns the fastening by means of screws. In particular, it was found that a fixing by means of adhesive—among other things due to the frequent temperature fluctuations—is not robust enough. The disclosure is further based on the discovery that, for example, snap-in connections are also too complex to fix the aluminum plates to the housing shells. It was found that, for example, by means of blow molding or thermoforming, the fluid structure or fluid conduit can be integrated into the housing wall or into the wall body itself. The disclosure is based on the finding that this significantly reduces the effort involved.

Furthermore, it was found that embedding the fluid structure or fluid conduit in the wall achieves a strong connection that makes elaborate clamping, locking or screw connections redundant and even surpasses them in terms of durability. Furthermore, the disclosure is based on the realization that this wall allows for efficient temperature control. This is surprising in that the aluminum plates from the prior art are very good heat conductors.

However—and this is a further finding of the disclosure—plastic materials for the housing wall are sufficiently thermally conductive due to their great design diversity to achieve a high-performance temperature control. In particular, the fluid conduit can be located almost directly on the inside of the housing wall, so that the battery cells come into direct or almost direct contact with the fluid conduit. In addition, the fluid conduit or the housing wall can be provided with additives that allow greater thermal conductivity. Furthermore, an insulating layer outside the fluid conduit can ensure that the cold or heat of the fluid conduit primarily penetrates inwards. These numerous possibilities result in a reduced effort regarding the manufacturing of the battery housing without impairing the performance of the temperature control. The task mentioned at the beginning is solved with the battery housing according to the disclosure.

The term “electric vehicle battery” preferably refers to a battery for driving an electric motor that can accelerate the vehicle. In particular, the term “electric vehicle battery” does not refer to batteries that only drive smaller electric motors such as those used for starters or pumps. The electric vehicle battery is preferably a source of energy for an electric motor used to accelerate an electric vehicle or a hybrid vehicle.

The housing wall is a part of the battery housing. The battery housing may have other elements in addition to the housing wall that are not counted as part of the housing wall. These include, for example, connecting elements, e.g. screws, or sealing elements such as a sealing ring.

The term “embedded” preferably means that in a cross-section of the housing wall, at least 1/10, ⅛, ⅙, ¼, ⅓, ½ or ⅔ of the expansion of the fluid conduit in the height direction or z-direction is surrounded by material of the housing wall and is preferably in contact with this material. The material of the housing wall is preferably connected to the fluid conduit in a form-fitting and/or materially integral manner. It is highly preferred that the material of the housing wall be materially integrally connected to the fluid conduit, in particular by means of a thermal process.

The directions are advantageously expressed using the Cartesian coordinate system. It is preferred that the x-direction corresponds to the greatest expansion of the battery housing or the electric vehicle battery. The z-direction corresponds preferably to the smallest expansion of the battery housing. The direction perpendicular to the z- and x-directions is expediently the y-direction. In this embodiment, the z-direction corresponds to the height direction of the installed electric vehicle battery in the vehicle. Advantageously, the x-direction corresponds to the direction along the vehicle or the direction of travel.

The arrangement of battery cells within the battery housing defines the directions or positional information “inside” and “outside”. For example, if one layer of the housing wall is closer to the battery cells than another layer, then the one layer is arranged within the other layer. The terms “inside” and “outside” preferably refer to the entire battery housing and not to a section of a wall.

According to another embodiment, the housing wall comprises an outer layer and an inner layer. The fluid conduit is preferably at least partially and preferably completely embedded in the z-direction in the inner layer—over at least one surface area. It is advantageous if the fluid conduit is embedded only in the inner layer. It is possible that an adhesive is located between the fluid conduit and the outer layer. Preferably, there is a form fit between the inner layer and the fluid conduit. Most particularly preferably, there is a material fit between the inner layer and the fluid conduit. It is preferred that the inner layer encloses at least 1 or 2 or 4 or 6 or 8 or 10 or 12 or 14 mm of an outer section of the fluid conduit. It is particularly preferred that the housing wall is formed on its inside so that it can come into flat contact with battery cells. This has the effect that the fluid conduit can extend particularly close to battery cells, whereby a good heat exchange is achieved. Another advantageous effect is that the fluid conduit is enclosed by the outer layer, whereby a corresponding stability of the battery housing is ensured. This also causes the fluid conduit to be sealed on the inside of the housing wall by a material, so that a particularly reliable and stable arrangement of the fluid conduit is provided.

It is preferred that the fluid conduit and/or the outer layer and/or the inner layer comprise a plastic. This results in a particularly low manufacturing cost with particularly low energy costs. In addition, the plastic material allows for a high degree of design flexibility. It is highly preferred that the plastic is a thermoplastic. Preferably, the plastic of the housing wall or the inner layer or the fluid conduit comprises an additive for increasing the thermal conductivity of the plastic of the inner layer or the fluid conduit. The additive preferably comprises a conductive soot. The layer thickness of the inner layer is advantageously at least 1 or 1.5 or 2 or 3 or 4 or 6 or 8 or 10 or 12 or 14 mm. It is preferred that a layer thickness of the outer layer is at least 2 or 3 or 4 or 6 or 8 or 10 or 12 or 14 mm.

According to another embodiment, the battery housing or the housing wall comprises at least two wall bodies and in particular two casing shells. Advantageously, the battery housing or the housing wall comprises a lower wall body and an upper wall body. Suitably, the lower wall body comprises a side wall. The upper wall body may have a side wall. It is preferable for the upper wall body to include a ceiling. It is preferable for the lower wall body to have a bottom. It is preferable for connecting elements or the connecting elements to be connected to the side wall of the lower wall body and/or to the side wall of the upper wall body. It is preferable if the housing wall comprises only two wall bodies, so that after the lower wall body has been connected to the upper wall body, the battery cells can be completely enclosed. It is possible that the upper wall body does not comprise a side wall or only has a ceiling.

It is advantageous if the upper wall body and the lower wall body are reversibly connected or can be connectable to one another. It is advantageous for the battery housing to comprise a seal. The seal advantageously comprises a sealing ring. The seal or the sealing ring is preferably arranged between the lower wall body and the upper wall body. Preferably, the seal is at least partially and advantageously completely designed to run along the side wall of the lower wall body. The sealing ring advantageously comprises an elastomer. The seal can have a sealing groove in the upper and/or in the lower wall body, in which the sealing ring is advantageously inserted.

According to another embodiment, the fluid conduit comprises at least one bend. The at least one bend of the fluid conduit is preferably at least partially and preferably completely embedded in the housing wall or in the inner layer. It is preferred that the fluid conduit has several bends. It is particularly preferred that the fluid conduit runs, at least in sections, in a meandering manner. It is preferred that the fluid conduit comprises at least one and preferably several straight sections. It is advantageous that the at least one straight section of the fluid conduit is at least partially and preferably completely embedded in the housing wall or in the inner layer. It is advantageous if an external diameter of the fluid conduit is at most 40, 30 or 25 mm. Preferably, an outer diameter of the fluid conduit is at least 8, 10 or 12 mm. It is preferred that an inner diameter of the fluid conduit is at least 6, 8 or 10 mm. Advantageously, an inner diameter is at most 35, 25 or 20 mm.

Preferably, a first end and/or a second end of the fluid conduit protrudes inward from the housing wall. It is advantageous for the battery housing to include a first connecting tube. Preferably, the first connecting tube connects the first end of the fluid conduit to/at the first fluid connection of the battery housing. The battery housing advantageously includes a second connection tube. The second connection tube usefully connects the second end of the fluid conduit to a/the second fluid connection of the battery housing.

It is preferred that the battery housing or the housing wall comprises at least a first fluid connection and preferably a second fluid connection. The first and/or second fluid connection is preferably designed as a plug-in element, in particular as a plug or socket. The first fluid connection and/or the second fluid connection is designed to establish a fluidic connection and a mechanical lock by only one plugging operation with the connection pipe and/or with pipes outside the battery housing. The first fluid connection and/or second fluid connection is advantageously part of a quick coupling. The first fluid connection and/or the second fluid connection preferably projects outwards with respect to the housing wall. Advantageously, the first fluid connection is connected to a first opening in the housing wall-in particular with a material bond—and is preferably inserted into the first opening. It is advantageous for the second fluid connection to be connected to a second opening in the housing wall—in particular with a material bond—and preferably inserted into the second opening.

It is preferred that the first connection tube connects the first end of the fluid conduit to the first fluid connection. It is expedient that the second connection tube connects the second end of the fluid conduit to the second fluid connection. It is advantageous that the first fluid connection and/or the second fluid connection comprises an outer plug-in element, which projects outwards with respect to the housing wall and/or an inner plug-in element, which projects inwards with respect to the housing wall.

According to a preferred embodiment, the material of the housing wall or of the inner layer and/or of the outer layer comprises fibers. The fibers preferably comprise glass fibers. It is preferred that the proportion of fibers in the material of the inner layer and/or the outer layer is at least 10 or 15 or 20% by weight, respectively. The material of the inner layer and/or the material of the outer layer advantageously includes a flame retardant. The flame retardant advantageously meets at least the category V2 of the standard UL 94. The material of the first layer and/or the second layer advantageously comprises a polyolefin and in particular a polypropylene.

An electric vehicle battery preferably comprises a battery housing according to the disclosure and battery cells. The electric vehicle battery advantageously comprises at least one electrical or electronic component. The at least one electrical or electronic component can be a control device, a sensor or an electrical connection.

The problem mentioned at the start is solved by using a battery housing in accordance with the disclosure for an electric vehicle battery or by using an electric vehicle battery in accordance with the disclosure in an electric vehicle or hybrid vehicle.

A method for manufacturing a battery housing and, in particular, a battery housing according to the disclosure, is also provided wherein a fluid conduit is placed in a mold for molding a part of the battery housing or a housing wall or a wall body, whereupon a material of a housing wall or of a wall body for embedding the fluid conduit in the housing wall or in the wall body is then introduced into the mold.

The method for producing the battery housing preferably comprises a blow molding operation and/or a thermoforming operation. It is preferred that an/the outer layer and/or the inner layer of the housing wall or of the wall body is/are produced by means of blow molding or by means of thermoforming.

Advantageously the fluid conduit is then introduced into the mold or into the housing wall or into the wall body or is arranged on an inner side of the outer layer. It is highly preferred that the wall body comprises a bottom or a ceiling and a side wall. Preferably, after the fluid conduit has been inserted or arranged on an inner side of the outer layer of the wall body or the housing wall, an inner layer is applied by means of blow molding or by means of thermoforming on the inside of the outer layer.

### BRIEF DESCRIPTION OF THE DRAWINGS

Two embodiments of the disclosure will be explained below with reference to several figures. The following figures show schematically

FIG. 1 an exploded view of an electric vehicle battery with a battery housing according to the disclosure,

FIG. 2 shows a plan view of a section of the bottom of a lower wall body of the battery housing,

FIG. 3 shows a cross-section through the section of FIG. 2,

FIGS. 4A-F show a sequence of process steps of a first process example and

FIGS. 5A-F show a sequence of process steps of a second process example.

### DETAILED DESCRIPTION

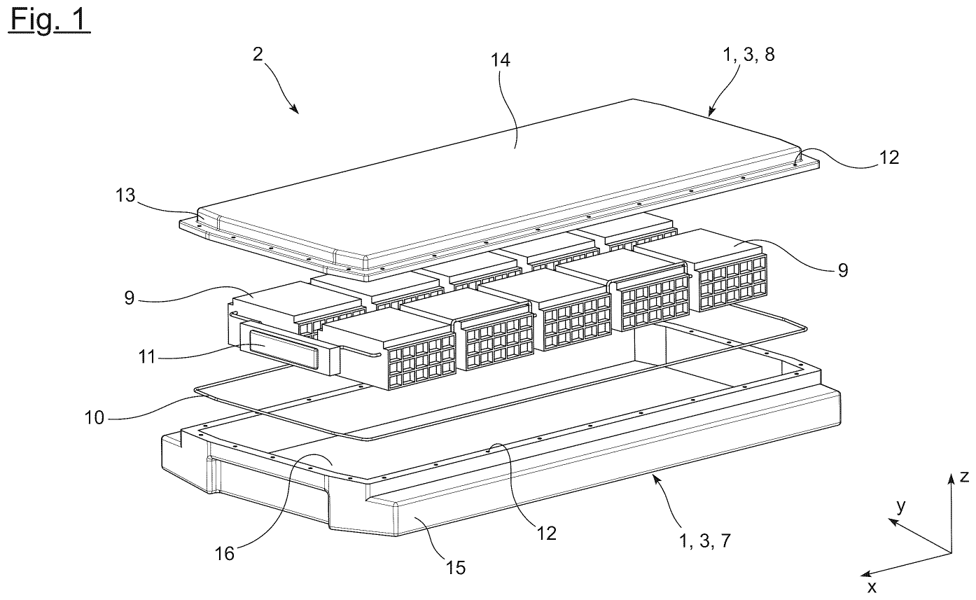

FIG. 1 shows an electric vehicle battery 2 of an electric vehicle. The electric vehicle battery 2 is useful for providing electrical energy to drive an electric motor that can accelerate the electric vehicle. The electric vehicle battery 2 includes a battery housing 1 and a plurality of battery cells 9. In addition, a plurality of electrical or electronic components 11 can be arranged within the battery housing 1. These include, in addition to electrical connections of the battery cells 9, for example electronic control units and sensors.

As shown in FIG. 1, directions are advantageously expressed using the Cartesian coordinate system. It is preferred that the x-direction is oriented in the direction with the greatest expansion of the battery housing 1 or the electric vehicle battery 2 in one direction. The z-direction corresponds preferably to the direction with the least expansion of the battery housing 1. The direction perpendicular to the z- and x-directions is expediently the y-direction. In this embodiment, the z-direction corresponds to the vertical direction of the installed electric vehicle battery in the vehicle. Advantageously, the x-direction corresponds to the longitudinal direction of the vehicle or the direction of travel.

The battery housing 1, according to FIG. 1, includes a housing wall 3 and advantageously a plurality of connecting elements 12. The connecting elements 12 are preferably screws. The battery housing 1 or the housing wall 3 preferably includes two wall bodies 7, 8. The battery housing 1 and the housing wall 3 are preferably subdivided in the z-direction into the two wall bodies 7, 8. It is advantageous that one of the two wall bodies 7, 8 is a lower wall body 7. The other of the two wall bodies 7, 8 is advantageously the upper wall body 8. The wall bodies 7, 8 are advantageously connected or connectable to one another via the connecting elements 12. The connecting elements 12 preferably comprise screws.

The battery housing 1 advantageously includes a seal, see FIG. 1. The seal advantageously comprises a sealing ring 10, which is preferably arranged between the lower wall body 7 and the upper wall body 8. Preferably, the lower wall body 7 and/or the upper wall body 8 or the seal has a sealing groove into which the sealing ring 10 can be or is inserted.

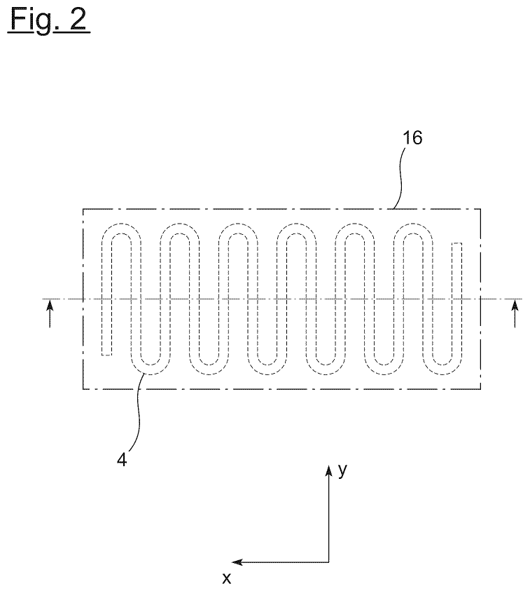

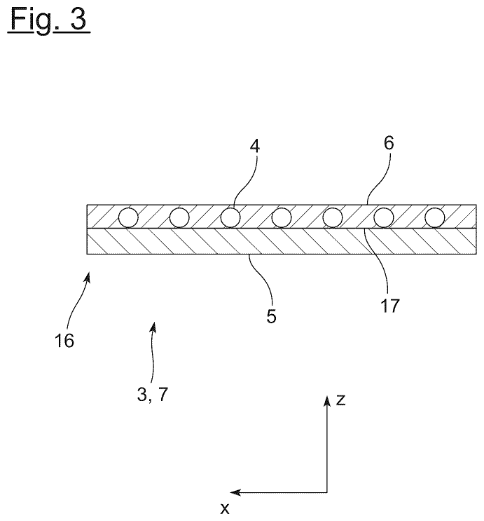

Preferably, the lower wall body 7 and/or the upper wall body 8 is/are designed as a housing shell as shown in FIG. 1. The lower wall body 7 advantageously has a circumferential side wall 15 at least in some sections. Preferably, the lower wall body 7 comprises a bottom 16. It is advantageous if the upper wall body 8 comprises an at least partially circumferential side wall 13. It is preferred if the lower wall body 7 has a bottom 16 and the upper wall body 8 has a ceiling 14. The upper wall body 8 advantageously forms a lid for the lower wall body 7. It is practical for the battery cells 9 to be arranged between the lower wall body 7 and the upper wall body 8. Temperature control elements and, in particular, a fluid conduit 4 (see, in particular, FIGS. 2 and 3) of the battery housing 1 and of the electric vehicle battery 2, respectively, have been omitted in FIG. 1 for the sake of clarity.

FIG. 2 shows a plan view of a section of the bottom 16 of the lower wall body 7. In particular, the side wall 15 of the lower wall body 7 is not shown in FIG. 2. In this embodiment a fluid conduit 4 is embedded in the bottom 16 of the lower wall body 7 and preferably not readily visible to the naked eye. For this reason, the fluid conduit 4 is only shown as a dashed line in FIG. 2. The fluid conduit 4 is preferably designed in a meandering shape or as a temperature control coil.

The upper wall body 8 advantageously includes a fluid conduit, not shown here, which is preferably formed in a meandering shape. It is preferred that the fluid conduit of the upper wall body 8 be embedded in the ceiling 14 of the upper wall body 8.

The dashed line along the section shown in FIG. 2 defines the FIG. 3 cross-section through the bottom 16 of the lower wall body 7. Preferably, the housing wall 3 or the lower wall body 7 and/or the upper wall body 8 comprises an outer layer 5 and an inner layer 6. It is preferred that the fluid conduit 4 is in the inner layer 6 of the lower wall body 7 and/or the upper wall body 8 at least partially and preferably completely embedded.

It is advantageous for an interface layer 17 to be located between the outer layer 5 and the inner layer 6 of the lower wall body 7 and/or the upper wall body 8. The interface layer 17 of the lower wall body 7 and of the upper wall body 8 is preferably an interface layer at which the outer layer 5 and the inner layer 6 have formed a material bond. The material bond in this embodiment is preferably produced by at least one of the two layers, in particular the inner layer 6, being applied in a heated state to the other layer, in particular to the outer layer 5.

In this embodiment, the fluid conduit 4 of the lower wall body 7 and/or of the upper wall body 8 has an outer diameter of 18 mm and an inner diameter of 16 mm. The fluid conduit 4 of the lower wall body 7 and/or of the upper wall body 8 preferably comprises a plastic and, in particular, a thermoplastic. Advantageously, the fluid conduit 4 is produced by extrusion. The fluid conduit 4 preferably comprises a polypropylene.

It is preferred that the outer layer 5 and/or the inner layer 6 of the lower wall body 7 and/or of the upper wall body 8 comprises a polypropylene. Preferably, the outer layer 5 and/or the inner layer 6 of the lower wall body 7 and/or of the upper wall body 8 comprises a reinforcing material, more preferably fibers and particularly preferably glass fibers. Advantageously, the proportion of the reinforcing material in the outer layer 5 and in the inner layer 6, respectively, is at least 25%. It is preferred that the outer layer 5 and/or the inner layer 6 has/have a flame retardant.

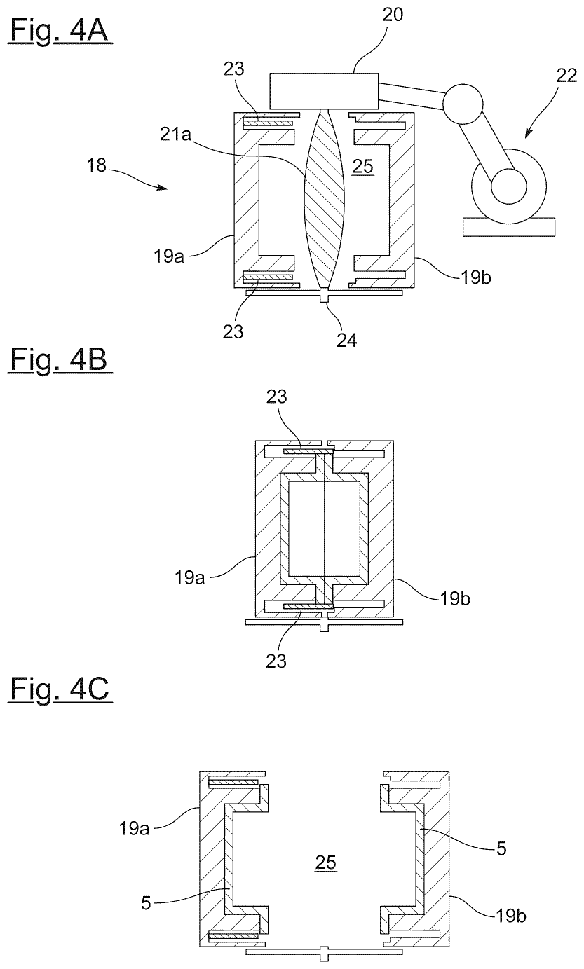

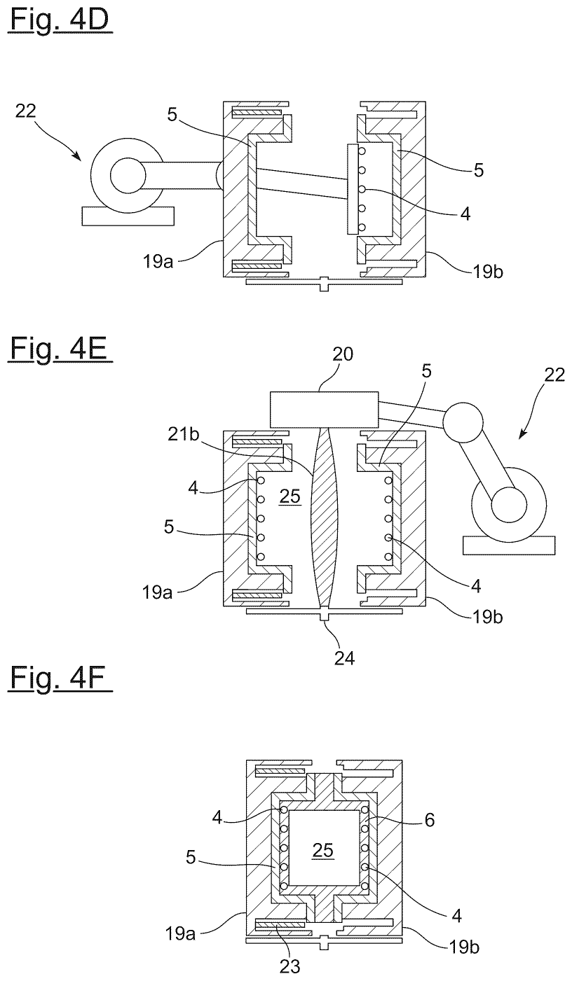

FIGS. 4A to 4F show a sequence of process steps of a first, exemplary manufacturing method for the battery housing 1, the housing wall 3, the lower wall body 7 and the upper wall body 8. In particular, the manufacturing process of the first embodiment is a blow molding process.

According to the first embodiment or FIG. 4A, a manufacturing apparatus 18 for manufacturing a battery housing comprises a first mold 19a and a second mold 19b, which are preferably movable relative to one another and are preferably movable towards each other. The direction of movement is advantageously horizontal. The first mold 19a and the second mold 19b advantageously define a variable cavity 25 between them.

It is advantageous that a first blank 21a is, advantageously by means of a blank feeding apparatus 20—is inserted into the cavity 25. Preferably, the manufacturing apparatus 18 comprises a robot 22. The robot 22 is designed so that it moves the blank feeding apparatus 20 in such a way that the first blank 21a is inserted into the cavity 25. It is advantageous the blank feeding apparatus 20 is arranged on the robot 22 or at one end of the robot 22. It is preferred that the manufacturing apparatus 18 comprises a blow molding apparatus 24. The blow molding apparatus 24 is advantageously designed so that a pressurized gas, in particular compressed air, can enter the first blank 21a and inflate the, advantageously heated, first blank 21a.

In FIG. 4B, the molds 19a and 19b have been moved towards each other compared to FIG. 4A so that the cavity 25 has been closed. Then first blank 21a is inflated until the first blank 21a assumes the contour of cavity 25 or the inside of the first mold 19a and the second mold 19b in the closed state. Preferably, as soon as the first blank 21a has at least partially solidified due to cooling, a separation apparatus 23 is moved through the inflated and solidified first blank 21a. The separation apparatus 23 advantageously moves between the molds 19a, 19b. This results in preferably two bodies or shells, each with an outer layer 5.

After that, preferably the molds 19a and 19b are moved apart in order to enlarge the cavity 25, as shown in FIG. 4C. Then preferably, as shown in FIGS. 4D and 4E, at least one fluid conduit 4 for each body/shell/mold or outer layer 5 is introduced into the cavity 25. It is advantageous if the at least one fluid conduit 4 is introduced into the cavity 25 with the aid of a/the robot 22. Expediently at least one fluid conduit 4 is placed on an inner side/body of an outer layer 5. It is particularly advantageous to place a fluid conduit 4 on each respective inner sides of the two layers 5 or shells/bodies. The placement of the fluid conduit 4 can be supported by adhesion. It is possible that an adhesive is located between the fluid conduit 4 and the shell or outer layer 5. For this purpose, the robot can moisten the fluid conduit 4 with adhesive before insertion into the cavity 25.

It is preferred that the manufacturing apparatus 18 or a robot 22 with a blank feeding apparatus 20 inserts a second blank 21b into the cavity 25, see FIG. 4E. It is expedient for the two molds 19a and 19b to then be moved towards each other to close the cavity 25.

It is advantageous that thereafter a/the blow molding apparatus 24 injects a pressurized gas into the second blank 21b, causing the second, suitably heated, blank 21b to expand, see FIG. 4F. It is particularly advantageous if the second blank 21b embeds the at least one fluid conduit 4 or the two fluid conduits 4 in itself. It is advantageous if, after solidification of the second blank 21b, the second blank 21b has become an inner layer 6, in which the fluid conduit 4 or the fluid conduits 4 is/are embedded.

After that, in this first embodiment, the separation apparatus 23 preferably cuts through the solidified body 5, 6 (not shown here) along a cutting direction, preferably analogous to FIG. 4B. The results in two wall bodies 7, 8. It is possible that after the cutting process by the separation apparatus 23, a lower wall body 7 and an upper wall body 8 are present. After the cutting process with the separation apparatus 23, two lower wall bodies 7 or two upper wall bodies 8 may exist.

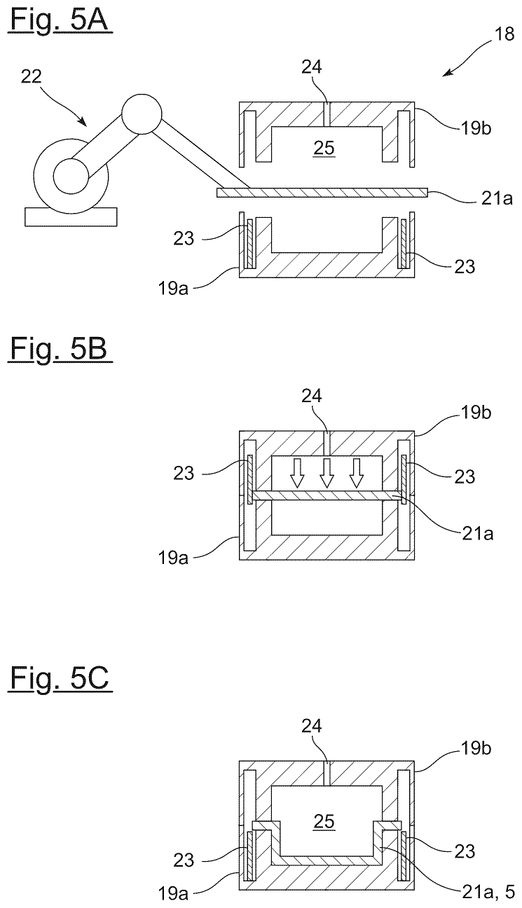

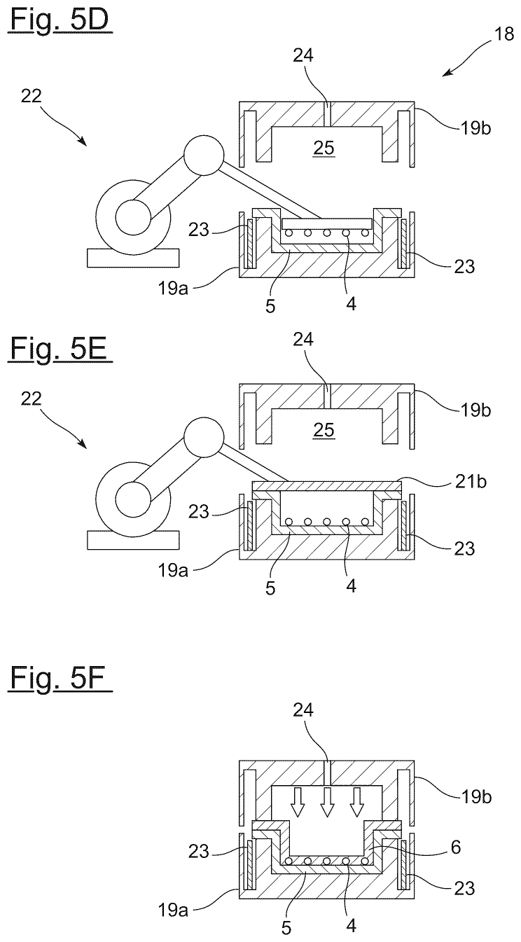

A second embodiment for manufacturing a battery housing 1 or a housing wall 3 is shown in FIGS. 5A to 5F. A manufacturing apparatus 18 is preferably designed as a thermoforming device and comprises a first mold 19a and preferably a second mold 19b. In this embodiment, however, the second mold 19b is not formative for the products to be manufactured, as will be explained below.

The manufacturing apparatus 18 of the second embodiment preferably comprises a separation apparatus 23, which can be movable in the height direction. It is preferred that the manufacturing apparatus 18 of the second embodiment has a robot 22. The robot 22 is preferably designed to introduce a first blank 21a into a cavity 25 between the first mold 19a and the second mold 19b. In Unlike the first embodiment, the first blank 21a of the second embodiment is preferably in the form of a rigid plate and not a hollow or curved preform.

Expediently, after the first blank 21a has been introduced into the cavity 25, the first mold 19a and the second mold 19b are moved towards each other so that the cavity 25 is closed. It is possible that the first mold 19a and the second mold 19b move towards each other in the height direction. The first mold 19a can be arranged below the second mold 19b. It is expedient to clamp the first blank 21a between the first mold 19a and the second mold 19b. It is then advantageous to activate the separation apparatus 23 so that the edges of the first blank 21a can be cut off.

It is preferred that the manufacturing apparatus 18 or the second mold 19b comprises a blow molding apparatus 24. The blow molding apparatus 24 preferably comprises a nozzle which blows a pressurized gas into the cavity 25. This creates a pressure in an upper region of the cavity 25. Advantageously, heat is applied to the cavity 25 or to the first blank 21a. Preferably, the application of heat to the first blank 21a and gas pressure cause the first blank 21a to assume the contour of the first mold 19a, see FIG. 5C. It is preferred that the deformed first blank 21a of the outer layer 5 corresponds to a wall body 7, 8.

Preferably, the molds 19a, 19b are then moved apart, so that the cavity 25 is opened, see FIG. 5D. It is useful for a robot 22 to then insert a fluid conduit 4 into the cavity 25, so that the fluid conduit 4 rests against an inside of the outer layer 5, as shown in FIG. 5D.

It is advantageous if the robot 22 then introduces a second blank 21b into the cavity 25, see FIG. 5E. The second blank 21b is preferably designed as a rigid plate. The first blank 21a and/or the second blank 21b can be adapted to the extension of the first mold 19a, so that a separation apparatus on the mold 19a is not absolutely necessary.

It is expedient that the molds 19a and 19b are then moved towards each other until the cavity 25 is closed. Then, advantageously, the second blank 21b is subjected to heat. It is advantageous for the second blank 21b to be subjected to pressure by means of a pressurized gas via the blow molding apparatus 24, as symbolized by the arrows in FIG. 5F. As a result, the second blank 21b takes on the shape predetermined by the first mold 19a or the outer layer 5 or the fluid conduit 4. After solidification, a wall body, in particular a lower wall body 7 or an upper wall body 8, exists.

### LIST OF REFERENCE NUMBERS

1 battery housing
2 electric vehicle battery
3 housing wall
4 fluid conduit
5 outer layer
6 inner layer
7 lower wall body
8 upper wall body
9 battery cell
10 sealing ring
11 electric or electronic component
12 connecting element
13 side wall of 8
14 ceiling of 8
15 side wall of 7
16 of 7
17 interface layer
18 manufacturing apparatus
19a First mold
19b Second mold
20 apparatus
21a First blank
21b Second blank
22 Robot
23 apparatus
24 Blow molding apparatus
25 Cavity

1. A battery housing for an electric vehicle battery, comprising a housing wall, wherein the housing wall comprises a plastic, wherein the battery housing at least comprises a fluid conduit for a temperature control medium, and wherein the fluid conduit is at least partly embedded in the housing wall.

2. The battery housing according to claim 1, wherein the housing wall comprises an outer layer and an inner layer, wherein the fluid conduit is embedded in the inner layer.

3. The battery housing according to claim 1, wherein the fluid conduit and/or the outer layer and/or the inner layer comprises a plastic.

4. The battery housing according to claim 1, wherein the battery housing or the housing wall comprises at least two wall bodies forming two housing shells.

5. The battery housing according to claim 1, wherein the fluid conduit has at least one bend and runs, at least in sections, in a meandering fashion.

6. The battery housing according to claim 1, wherein the battery housing or the housing wall has at least one fluid connection.

7. The battery housing according to claim 1, wherein the material of the housing wall or of the inner layer and/or the outer layer comprises fibers.

8. An electric vehicle battery comprising a battery housing configured according to claim 1, wherein the electric vehicle battery comprises battery cells.

9. Use of a battery housing configured according to claim 1 for an electric vehicle battery in an electric vehicle or hybrid vehicle.

10. A method for producing a battery housing configured according to claim 1, wherein a fluid conduit is placed into a mold for molding a part of the battery housing or a housing wall or a wall body, wherein a material of the battery housing or the housing wall or the wall body is introduced into the mold such that the fluid conduit is embedded into the battery housing, the housing wall or the wall body.

11. The battery housing according to claim 1, wherein the fluid conduit is embedded only in the inner layer.

12. The battery housing according to claim 4, wherein the two housing shells comprise an upper wall body and a lower wall body.

13. The battery housing according to claim 1, wherein the material of the housing wall or of the inner layer and/or the outer layer comprises glass fibers.
